(19) United States
(12) Patent Application Publication
(10) Pub. No.: US 2015/0088580 A1
(43) Pub. Date: Mar. 26, 2015

(54) METHOD FOR DEVELOPING OR MODIFYING A TECHNICAL PRODUCT

(71) Applicant: 4cost GmbH, BERLIN (DE)

(72) Inventors: Thomas Przybilla, Neu Isenburg (DE); Joachim Schöffer, Berlin (DE); Herbert Spix, Glashutten-Schlossborn (DE)

(21) Appl. No.: 14/389,391

(22) PCT Filed: Mar. 7, 2013
(86) PCT No.: PCT/EP2013/054550

§ 371 Date: Sep. 30, 2014

(30) Foreign Application Priority Data
Mar. 30, 2012 (DE) 10 2012 102 755.2

(51) Int. Cl. G06Q 10/06

(52) U.S. Cl. CPC G06Q 10/06313
USPC 705/7.23

(57) ABSTRACT

The invention relates to a method for producing a technical product, in particular vehicles, machines, technical instruments, apparatuses, and devices, comprising the following steps: planning material requirements and procuring material; planning and performing the processing of the procured material by means of labor in a plurality of manual or manually supported processing steps; planning and performing the machine processing in a plurality of machine process steps; and parametrically determining production costs of the individual technical product before the planning of the processing steps and process steps independently of the duration and quantity thereof using the following parameters: quantity of all produced products of said series, product weight of the individual technical product, quality requirements, and technology index for describing the technological complexity of the product. The method according to the invention is characterized in that the production costs determined in advance for the manual or manually supported processing steps and the production costs for the machine process steps are determined separately and separately from the material costs, and said separately determined production costs are used to plan and/or optimize all individual manual processing steps and automated process steps.

### CROSS REFERENCE TO RELATED PATENT APPLICATIONS

This patent application is filed herewith for the U.S. National Stage under 35 U.S.C. §371 and claims priority to PCT application PCT/EP2013/054550, with an international filing date of Mar. 7, 2013. The contents of this application are incorporated in their entirety herein.

### STATEMENT REGARDING FEDERALLY-SPONSORED RESEARCH OR DEVELOPMENT

Not applicable.

### TECHNICAL FIELD

The invention relates to a method for the production of a technical product, in particular vehicles, machines, technical instruments, apparatus and devices, comprising the steps of:
(a) planning material requirements and obtaining material;
(b) planning and carrying out the treatment of the obtained materials by means of manpower in a plurality of manual or manually supported processing steps;
(c) planning and carrying out the machine processing in a plurality of machine processing steps; and
(d) parametrically determining of the costs of the production of the individual technical product before planning the treatment and processing steps independent of their duration and their number using the following parameters:
   (i) number of the products produced in this series;
   (ii) product weight of the individual technical product;
   (iii) quality requirement, and
   (iv) technology index for describing the technological complexity of the product.

### BACKGROUND OF THE INVENTION

In many enterprises an estimate is made for the costs for the production of a technical product. Such a cost estimate serves, for example, to determine the price for sale on the market. If it is found that the production costs are so high that a price obtainable on the market cannot be achieved the enterprise still has the option to change the product itself or its production steps before its production in order to ensure its economic value. Alternatively, the early determination of the costs can cause a decision against a development. In such a way an unprofitable investment can be avoided. Also, the question if a product is offered for a fair value can be better answered by estimating the production costs.

The more complex a product is, the more difficult it will be to determine the production costs. Technologically complex products require a plurality of manual manufacturing steps and automatic machine processing steps in addition to the selection of a material for individual components.

The development of technical products, such as motor vehicles, planes, machines, apparatus, technical instruments and devices also includes the search for inexpensive treatment and processing steps, the minimization of the number of such steps and the optimization of the functionalities.

There is the possibility to determine the costs of a technical product by comparison to the production costs of a similar product. Very often, however, there is no reliable value available, the comparison product is too different or the production costs have changed in the course of time.

More accurate cost estimates are based on the exact analysis of the production process. All steps—by machines or manual steps by manpower—are determined in great detail and the costs are estimated. An hourly rate is assumed for the worker. The duration of each processing step is estimated. The generation of such a “bottom-up”—cost estimate requires much time and can last several years. Decisions will be taken very late or before the cost estimate is completed. The production process may then possibly not be optimized anymore.

Depending on the applicable hourly rate the cost estimates may vary to a large extent. However, it was found that a low hourly rate causes costs for the removal of the production to so-called low-cost countries which at least partly compensate for the low hourly rate.

It is, therefore, desirable to provide a method which quickly and reliably generates a cost estimate which indicates the overall costs for a technical product independently of the hourly rate.

U.S. Pat. No. 6,073,107 (Minkiewicz) discloses software for estimating the working hours for the development and production of a product.

U.S. Pat. No. 5,793,632 (Fad) discloses a cost estimating model where hourly rates for the working people can be directly inserted. The model requires the dismantling of the production process in individual steps before the costs can be estimated.

On the website www.4cost.de the applicant provides a cost estimation program where the costs for the production of a technical product can be reliably estimated independently of the hourly rate of a worker and before dismantling of the manufacturing process into individual steps.

A known finding is used therein, according to which the costs are represented by a decreasing so-called “learning curve”. In the learning curve the production costs are a function of the number of pieces. This results in a decreasing curve towards a fixed value. Accordingly, the costs for the production of a low number of pieces is higher than the costs for the production of a very high number of pieces. This is caused by the fact that the workers involved with the production will operate faster, with greater ease and higher precision upon repeating their operations. Also, the costs for setting up machines are distributed on a higher number of pieces.

The distribution of the learning curve depends on the technical complexity of the technical product. A technically simple product has a flat learning curve. This means that the workers can work on the product in the early stages already with low time requirement and high precision, i.e. with minimum costs. A technically complex product, however, has a steep learning curve. It takes some time until the workers can carry out their tasks with minimum costs. This behavior is the same with automatized productions. Full automatization has a flat learning curve, i.e. the cost reduction does not involve any learning, but the reduction is determined by more or less use of the material. Manual works, such as, for example, mounting and assembling, integrating of complex products involve a very high learning effect. The cost reduction from piece to piece can be significant.

This is represented by the learning curve index. The curvature of a typical learning curve for manual work has an index of 0.8. This means that the costs of the second piece are 80% of the costs of the first piece, the costs of the 4th piece are 80% of the costs of the second piece, the costs of the 8th piece are 80% of the costs of the 4th piece and so on.

### BRIEF SUMMARY OF THE INVENTION

It is an object of the invention to provide a method of the above mentioned kind which improves the reliability of previous cost estimates without the exact knowledge of the individual steps of the production process and enables the planning of the treatment and processing steps at an early stage.

According to an aspect of the invention this object is achieved in that
(e) the production costs determined beforehand for the manual or manually supported processing steps and the production costs for the machine processing steps are determined separately and separate from the material costs; and
(f) such separately determined production costs are used for the planning and/or optimizing of all individual manual treatments and automatized processing steps.

The invention uses the finding that material costs for the production of a piece are generally independent of the number of pieces. Accordingly, such material costs can be typically removed from the learning curve. Also, the production costs caused by automatic machine processing steps are almost independent of the number of pieces. Once a machine is set up the first piece is produced with the same precision and the same speed as the last piece.

Learning curves are well known from experience values. The separation of the three cost portions material, manual treatment and machine processing therefore enables a very precise determination of the portion for manual treatment, i.e. the amount of work for human resources.

According to the invention the cost estimate obtained in such a way can be used as a basis for optimizing the production process. Contrary to known methods the costs for manual treatment steps and machine processing steps are known separately and can be used for optimization.

In a preferred embodiment of the invention a component index is determined for individual components of the technical product and the technology index is derived for the entire technical product from such component indices. For this purpose the technical product is divided to individual components. The technology index for such components—here called component index—can be determined with higher accuracy. Here also the complexity of the product is reflected by an index. It was found that most technical products consist of components which have previously been used many times and for which, therefore, the technology index is well known. The technology index for such components can be stored, for example, in the form of a table. In such a way the technology index for new developments can be determined with very high accuracy even if such developments have never been estimated before.

In addition, the division of the technical product into its components will provide information about the technical product which can be re-used in a later bottom-up estimate. If, for example, the required precision of a production step was determined and considered when the technology index of a component was determined such precision can be used also in a later bottom-up estimation. Such parameters may then be used for optimizing the production process.

In a further, advantageous modification of the invention the technology index and each component index is determined for mechanical-, electronic- and data processing components of the technical product independently from each other. Just like the division of the technical product into its components this enables the optimization of the production process.

The planning of the treatment- and processing steps can be effected therein under consideration of the portions of the mechanical- electrical- and data processing components.

In a particularly preferred embodiment of the invention it is provided that the material costs are derived from the gross weight of the final product. This is a very simple calculation which leads to very good results.

Furthermore, the machine costs can be derived from the kind and number of processing steps. As the machine costs are constant and will not change they can be determined with known methods in a relatively easy manner.

In a particularly advantageous embodiment of the invention the costs for manpower are determined independent from the hourly rate of a worker and are derived from the difference of the production costs and the sum of material and machine costs. Only this portion of the costs is not constant and decreases per piece with the amount of the produced pieces. Contrary to known devices no hourly rate is considered for this calculation.

Further modifications of the invention are subject matter of the dependent claims. An embodiment is described below in greater detail with reference to the accompanying drawings.

### BRIEF DESCRIPTION OF THE SEVERAL VIEWS OF THE DRAWINGS

The invention is explained in the following on the basis of preferred embodiments with reference to the accompanying drawings, in which:

FIG. 1 is a flow-chart illustrating the cost-optimized production process of a technical product; and

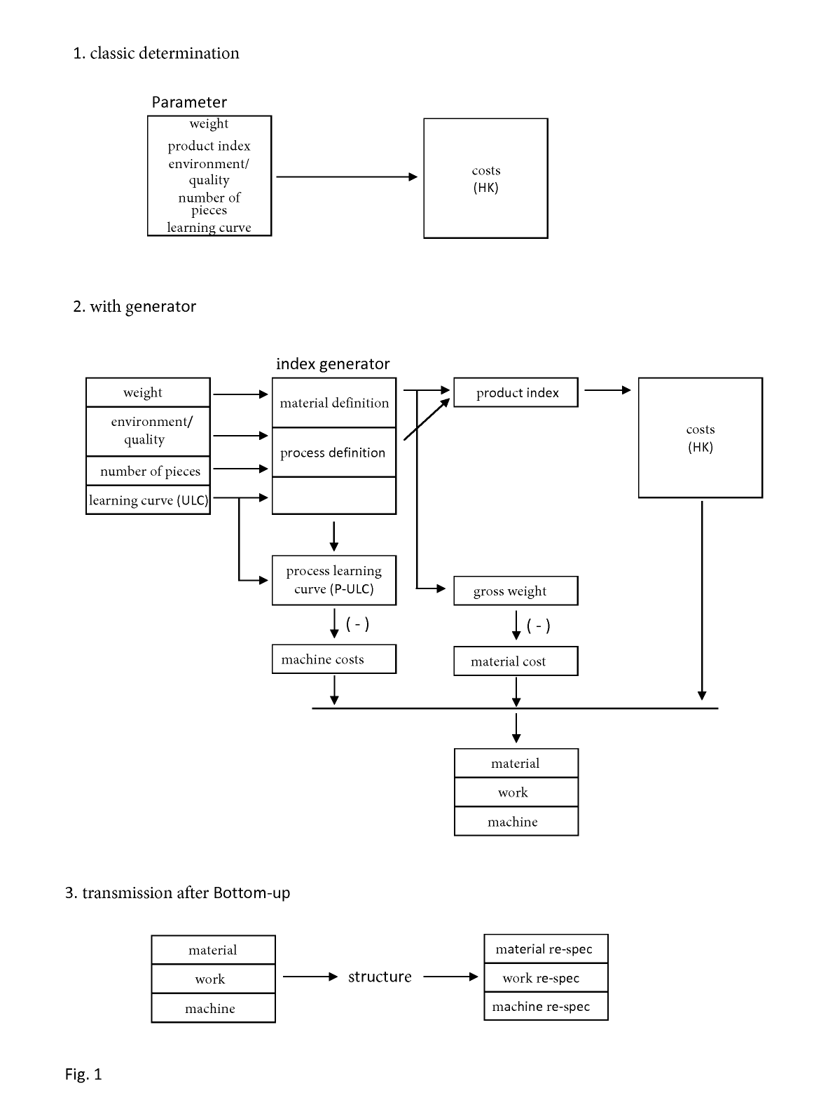

FIG. 2 shows a learning curve.

### DETAILED DESCRIPTION OF THE INVENTION

A typical technical product is a motor vehicle. By way of example of such a motor vehicle it is illustrated how the production process can be realized with optimized costs. It is understood, however, that any other technical product can be used instead of a motor vehicle, i.e. machines, airplanes, measuring instruments, consumer goods, scientific apparatuses and the like where material is developed to a product and produced using man power and machines.

In the present embodiment the motor vehicle constitutes a very complex product consisting of a plurality of components. Examples of such components are the car body, the on-board computer, the engine and the gear box.

In order to determine the price of a piece, the number of pieces intended for production, the predicted weight, the quality requirement and the technology index are determined.

The quality requirement is a value representing the environmental conditions. In the present example it makes a difference if the motor vehicle is intended for the use of transporting dangerous goods, for example, or if it is a passenger car manufactured in series. Special quality requirements must be considered in particular with products in the ranges of military use, medical use, air traffic, calibration, semiconductor industries and motor vehicles. It is understood, that this list is given only by way of example and by no means complete. Each quality requirement will cause an increase of the production costs and is considered in a corresponding quality index used for the cost estimate.

The technology index (also called product index) describes the technological complexity of a product. A jet engine control is generally technologically more complex than a simple pressing iron. The technology index is, therefore, larger for the jet engine control than for the pressing iron. Typical values for the technology index are between 0.001 for very simple products and 22 for very complex products.

There are components where a reliable technology index is known already and available in, for example, the form of tables. In this case such a technology index can be used. If the component, however, is much different to known components such a technology index may not be used anymore without compromising the quality of the cost estimate.

No technology indices are present for completely new developments. In this case the component is disassembled into further single pieces or components. Examples for such single pieces are the mounting of an engine, a cylinder, a cylinder head, a cylinder head gasket, a crank, a fuel injector, a spark plug, and so on. For some of such single pieces or components there may again not be any technology index available. They are then further disassembled into further single pieces or components, if necessary. In any case each component can be disassembled so far, that finally there are exclusively single pieces where the technology index can be calculated. It is important to note, that the disassembling considers if the piece is software, an electronic, mechanic or a combined component. The steps required for its production are divided to manual treatment steps and machine processing steps.

A shaft with a given weight and given length, for example, is turned with a lathe from raw material with known weight and diameters to its form, grinded, polished, hardened, and mounted. A technology index is calculated for each of such steps or adapted by experience values. A change of weight may occur during the process which is finally also considered. The shaft of this embodiment is partly machine processed and partly treated manually. In such a way the technology index is determined for the shaft and each other single piece. In other words: the technology index represents the value added to the raw material by man power and machines. In order to determine the technology index a database or an index generator can be used which combines and evaluates the individual experience values.

On one hand, the depth of the details for determining the technology index depends on the knowledge of the engineers and technicians concerned with the cost estimate. On the other hand a high depth of the details is only necessary if a high quality of the cost estimate is necessary. This may possibly not be required for an early first value.

An average technology index is determined after determining the component index for all components of the motor vehicle. From this technology index the costs per piece are determined. In addition to quality requirements, the number of pieces and the technology index, the material costs must be considered. The material costs of various materials are derived from the individual weights for each material in the final product.

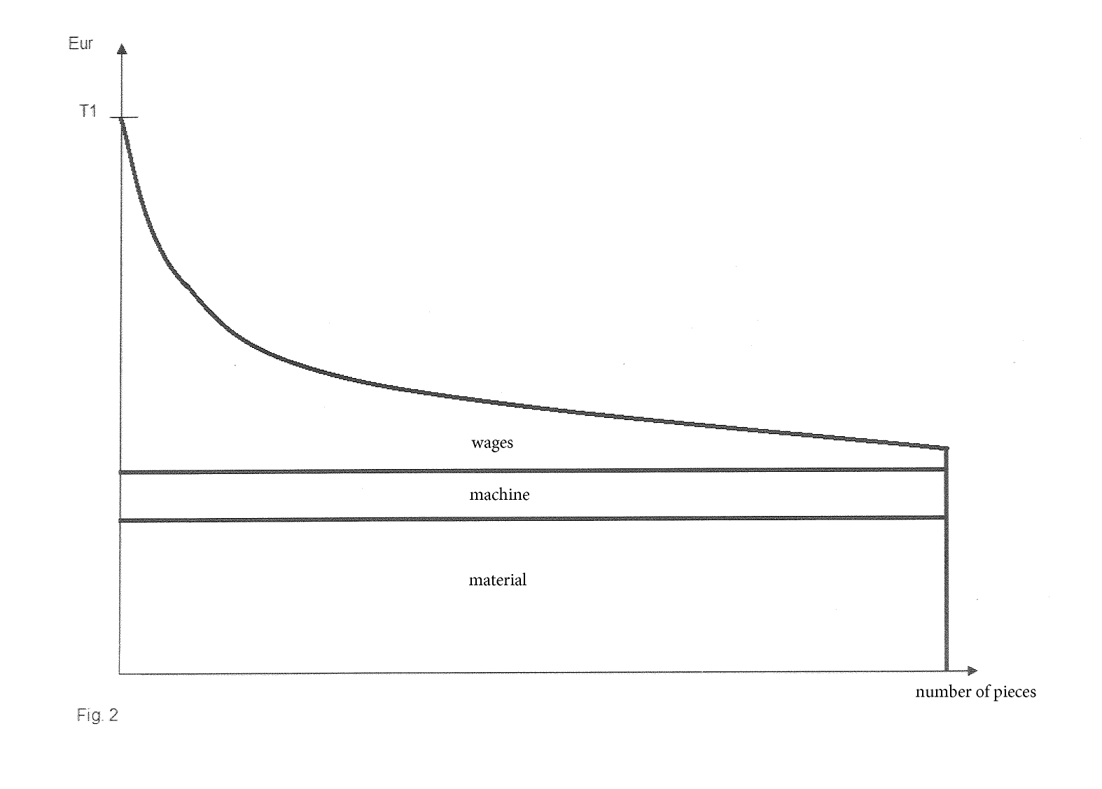

The value obtained according to the above mentioned method is a value parametrically determined from a learning curve not including any hourly rates. An example for a learning curve is shown in FIG. 2.

After determination of such an early first value often a bottom-up estimate is made where each individual working step, the corresponding hourly rates and machine costs etc. are included. With the present invention the details produced for the parametric estimate serves as an input for the bottom-up estimate.

The separation of the costs for material, human work and machines serves to optimize the individual processing and treatment steps.

What is claimed is:

1. A method for the production of a technical product, in particular vehicles, machines, technical instruments, apparatuses and devices in a series of individual technical products, said technical product having a product weight and requiring material, manual or manually supported treatment of said material by means of manpower and machine processing of said material, wherein said material, said treatment of said material by means of manpower and said machine processing of said material causes costs,
said method comprising the steps of:
(a) planning said material requirements and obtaining said material according to said material requirements;
(b) planning and carrying out said treatment of said obtained materials by means of manpower in a plurality of manual or manually supported processing steps;
(c) planning and carrying out said machine processing in a plurality of machine processing steps; and
(d) parametrically determining costs of the production of the individual technical product before said planning of said treatment and processing steps independent of their duration and their number using the following parameters:
(i) number of said individual products produced in said series;
(ii) said product weight of said individual technical product;
(iii) a quality requirement, and
(iv) a technology index for describing the technological complexity of said product;
and wherein
(e) said production costs determined beforehand for said manual or manually supported treatment steps and said production costs for said machine processing steps are determined separately and separate from said material costs; and
(f) said separately determined production costs are used for the planning and/or optimizing of all individual manual treatments and machine processing steps.

2. The method of claim 1, wherein a component index is determined for individual components of said technical product and said technology index is derived for the entire technical product from such component indices.

3. The method of claim 2, wherein said technology index and each said component index is determined for mechanical-, electronic- and data processing components of said technical product independently from each other.

4. The method of claim 3, wherein said planning of said treatment- and processing steps is effected under consideration of the portions of said mechanical- electrical- and data processing components.

5. The method of claim 1, wherein said material costs are derived from the gross weight of the final product.

6. The method of claim 1, wherein said machine costs are derived from the kind and number of processing steps.

7. The method of claim 1, wherein said costs for man power are independent from the hourly rate of a worker and are calculated from the difference of the production costs and the sum of material and machine costs.
